(19) United States
(12) Patent Application Publication
(10) Pub. No.: US 2009/0254628 A1
(43) Pub. Date: Oct. 8, 2009

(54) Method, System And Apparatus For Instant Messaging

(75) Inventors: Qian Yang, Shenzhen City (CN); Ziguang Gao, Shenzhen City (CN); Li Zhu, Shenzhen City (CN)

Correspondence Address: HARNESS, DICKEY & PIERCE, P.L.C., P.O. BOX 828, BLOOMFIELD HILLS, MI, 48303, US

(73) Assignee: TENCENT TECHNOLOGY (SHENZHEN) COMPANY LIMITED, Shenzhen City (CN)

(21) Appl. No.: 12/485,532

(22) Filed: Jun. 16, 2009

Related U.S. Application Data
(63) Continuation of application No. PCT/CN2007/071051, filed on Nov. 12, 2007.

(30) Foreign Application Priority Data
Dec. 19, 2006 (CN) 200610162294.3

(51) Int. Cl. G06F 15/16

(52) U.S. Cl. 709/206

(57) ABSTRACT

The present invention discloses a method and a system for implementing instant messaging using a browser. The method includes: a browser logs in an instant messaging background server, when receiving an instant message sent from a user, the browser establishes an HTTP link with an access server to send the instant message, the access server adds the instant message into an upload queue and checks whether there is an instant message to be sent to the user in a distribution queue, if there is, sends the instant message at the head of the distribution queue via the HTTP link and disconnects the HTTP link after the instant message is sent; otherwise, disconnects the HTTP link; when detecting that the HTTP link is disconnected, the browser re-establishes the HTTP link with the access server. The system includes a webpage server, a browser module and an access server.

### CROSS-REFERENCE TO RELATED APPLICATIONS

This application is a continuation of International Application No. PCT/CN2007/071051, filed Nov. 12, 2007. This application claims the benefit and priority of Chinese Application No. 200610162294.3 filed Dec. 19, 2006. The entire disclosures of each of the above applications are incorporated herein by reference.

### FIELD

The present disclosure relates to instant messaging fields, and more particularly, to method, system and apparatus for instant messaging.

### BACKGROUND

This section provides background information related to the present disclosure which is not necessarily prior art.

Up to the present, instant messaging has been accepted and approved by most network users and become an indispensable part of their lives. Instant messaging has been widely used in working as well as daily entertainments of the users.

In the prior art, all instant messaging systems adopt a Client/Server (C/S) architecture, wherein an instant messaging client is installed in a user terminal for providing functions such as input/output, information display and interface operations. A server configured on the network side is adapted to provide functions such as data storage, message forwarding and status maintenance, etc. To start instant messaging, a user may send login information to an access server on the network side through an instant messaging client installed in a user terminal. The login information may include a user account and a password. The access server forwards the login information to a background database for authentication. If the authentication is passed, the access server returns information such as friend information to the instant messaging client in the user terminal; otherwise, the user fails to login. After successfully logging in, the user may communicate with other online users through instant messaging.

Defects of the above prior art lie in that the terminal used by a user who desires to log in the instant messaging system has to be equipped with an instant messaging client, if not, the user has to download and install an instant messaging client before he/she logs in the instant messaging system via the instant messaging client to communicate with other online users. However, it is usually the case that there is no instant messaging client installed in the user terminal for reasons such as lack of time, hard-disk space or due to the operation system, while the user needs instant messaging services. For example, the user may accidentally need to temporally use a terminal without an instant messaging client. In this case, the user is unable to log in the instant messaging system for instant communications.

### SUMMARY

This section provides a general summary of the disclosure, and is not a comprehensive disclosure of its full scope or all of its features.

Embodiments of the present invention provide a method for instant messaging, so as to implement instant messaging without an instant messaging client.

Embodiments of the present invention also provide a system for instant messaging, so as to implement instant messaging without an instant messaging client.

Embodiments of the present invention also provide an apparatus for instant messaging, so as to implement instant messaging without an instant messaging client.

The solutions of the embodiments in accordance with the present invention are as follows.

A method for implementing instant messaging includes:

logging in, by a browser, an instant messaging background server through a webpage, sending and receiving instant messages through an access server.

A system for implementing instant messaging includes: a webpage server, a browser module and an access server,

the webpage server is adapted to provide a webpage to the browser module for instant messaging;

the browser module is adapted to obtain the webpage for instant messaging from the webpage server, log in an instant messaging background server through the webpage, establish an HTTP link with the access server, send and receive instant messages to and from the access server through the HTTP link; and

the access server is adapted to receive an instant message sent by the browser module through the HTTP link established with the browser module, forward the instant message to the instant messaging background server, receive an instant message sent by the instant messaging background server and forward the instant message to the browser module.

An access server includes: a format converting module, a message caching module, a message upload module, a checking module and a message distribution module;

the format converting module is adapted to receive a message sent from a browser, convert the message into a format of a protocol adopted by a background server, send the message to the message caching module, receive a message sent by the background server, and convert the message into a format of a protocol adopted by the browser and send the message to the message caching module;

the message caching module is adapted to cache the message sent from the format converting module;

the message upload module is adapted to send the message sent from the browser and cached in the message storage module to the background server;

the checking module is adapted to check whether there is a message in the message caching module to be sent to the browser, and send a message distribution instruction to the message distribution module if there is a message in the message caching module to be sent to the browser;

the message distribution module is adapted to receive the message distribution instruction from the checking module, send the message to be sent to the browser in the message caching module to the browser through an HTTP link.

Compared with the prior art, Asynchronous JavaScript and XML techniques are adopted in the technical solutions provided by the embodiments of the present invention. An HTTP link established between an XML HTTP Request (XHR) and an access server is used for transmitting a message to the access server. The access server adds the message to an upload queue and checks whether there is a message to be sent to the user in a distribution queue. If yes, send a message at the head of the distribution queue using the HTTP link and disconnect the link after the transmission is completed; otherwise, disconnect the link after a pre-defined time interval. After detecting that the link is disconnected, a browser re-establishes the HTTP link with the access server, so as to implement instant messaging via short links established successively between the browser and the access server.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flowchart illustrating the principle of a method for implementing instant messaging using a browser according to an embodiment of the present invention.

FIG. 2 is a flowchart illustrating a process of a user login an instant messaging background server and obtaining information of contacts via a browser according to an embodiment of the present invention.

FIG. 3 is a flowchart illustrating a process of a user exchanging messages with a background server via a browser according to an embodiment of the present invention.

FIG. 4 is a block diagram illustrating the structure of a system for implementing instant messaging using a browser according to an embodiment of the present invention.

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

To make the objective, technical solution and merits of the present invention clearer, the present invention will be described hereinafter in detail with reference to accompanying drawings and embodiments.

Embodiments of the present invention provide a solution for implementing instant messaging using a browser. In this solution, the browser sends a message to an access server through an HTTP link established between the browser and the access server. The access server adds the message to an upload queue and checks whether there is a message to be sent to the user in a distribution queue, if yes, sends the message at the head of the distribution queue via the HTTP link and disconnects the HTTP link after the message is sent; otherwise, disconnects the link after a pre-defined time interval. After detecting that the link is disconnected, the browser re-establishes the HTTP link with the access server, so as to implement instant messaging using successively established short links between the browser and the access server.

The technical solution of the present invention will be described in detail hereinafter with reference to the accompanying drawings.

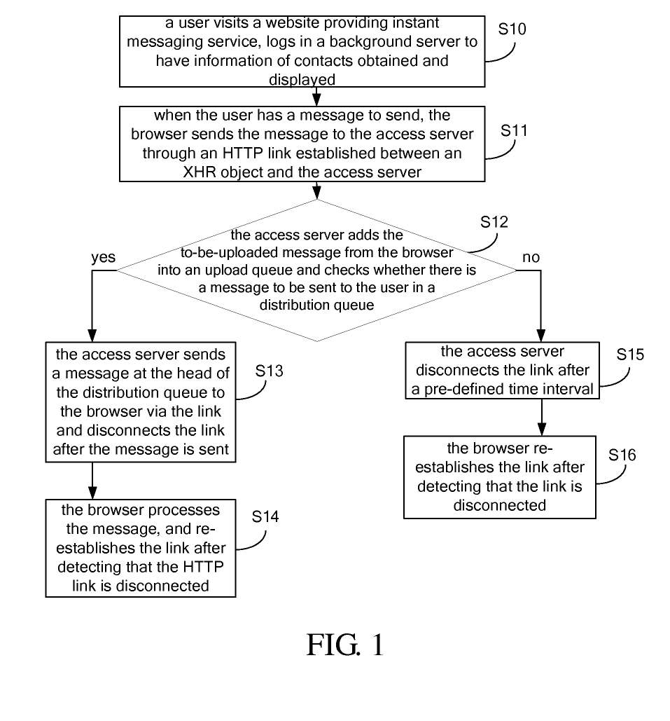

Refer to FIG. 1, which is a flowchart illustrating the principle of the method for implementing instant messaging using a browser. The method includes the following steps.

In step S10, a user visits a website providing instant messaging service through a browser, logs in a background server through the browser to have information of contacts obtained and displayed.

In step S11, when the user has a message to send, the browser sends the message to the access server through an HTTP link established between an XHR object and the access server, and designates a callback function for this kind of messages.

In step S12, the access server adds the message from the browser to an upload queue and checks whether there is a message to be sent to the user in a distribution queue, if yes, performs steps S13 and S14; otherwise, performs steps S15 and S16.

In step S13, the access server sends a message at the head of the distribution queue to the browser via the HTTP link and disconnects the HTTP link after the message is sent.

In step S14, the browser calls a callback function corresponding to the type of the message received to process the message. After detecting that the HTTP link is disconnected, the browser re-establishes the HTTP link with the access server.

In step S15, the access server disconnects the link after a pre-defined time interval.

In step S16, after detecting that the link is disconnected, the browser re-establishes the HTTP link with the access server.

The above describes an overall process of implementing instant messaging using a browser in accordance with an embodiment of the present invention. The detailed process of the browser login the instant messaging background server and obtains information of contacts will be described hereinafter.

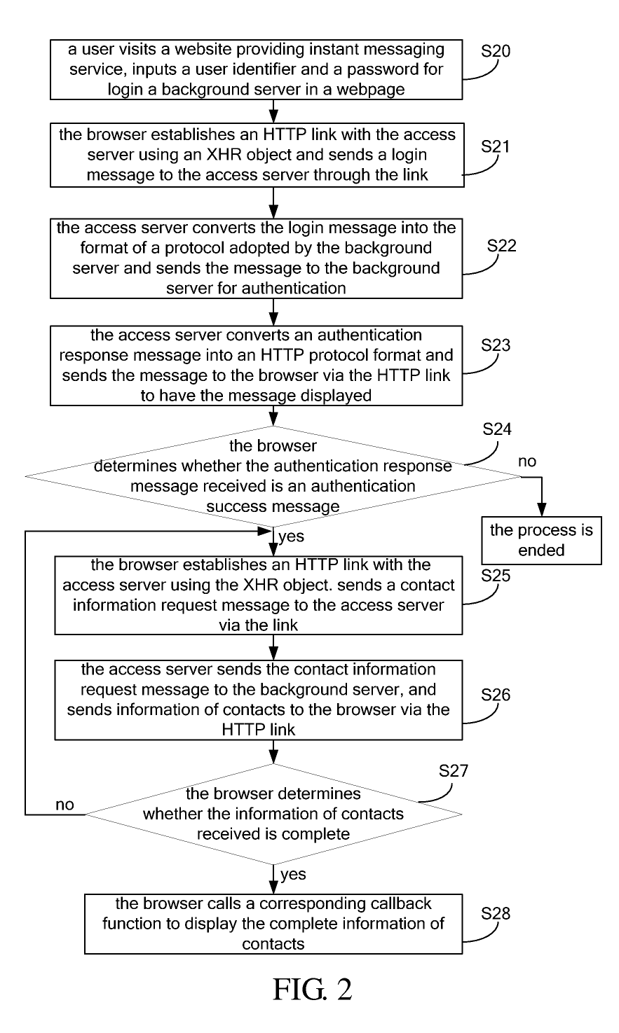

FIG. 2 is a flowchart illustrating a process of a user login an instant messaging background server and obtains information of contacts using a browser according to an embodiment of the present invention. As shown in FIG. 2, the process includes the following steps.

In step S20, a user visits a website providing instant messaging service using a browser, the browser receives a user identifier and a password inputted by the user for login an instant messaging background server.

In step S21, the browser runs a Java Script (JS) program to create an XHR object, establishes an HTTP link with the access server using the XHR object and sends a login message to the access server through the HTTP link. The login message carries the user identifier and the password of the user. Meanwhile, the browser designates a callback function for this type of message.

In step S22, the access server converts the login message into the format of a protocol adopted by the background server and sends the message to the background server for authentication.

In step S23, the background server authenticates the login message and sends the result of the authentication to the access server via an authentication response message. The access server converts the authentication response message into an HTTP protocol format and sends the message to the browser via the HTTP link established between the browser and the access server using an XHR object. The browser calls the callback function to process the authentication response message and display the authentication result in a webpage.

In step S24, the browser determines whether the authentication response message is an authentication success message, if yes, performs step S25; otherwise, ends the procedure.

In step S25, the browser determines whether there is an idle XHR object, if yes, the browser establishes an HTTP link with the access server using the idle XHR object; otherwise, the browser runs a JS script program in the webpage to create an XHR object and establishes an HTTP link with the access server using the XHR object. The browser sends a contact information request message to the access server via the established HTTP link and designates a callback function for this kind of messages.

In step S26, the access server converts the contact information request message into the format of a protocol adopted by the background server before sending the message to the background server, and sends information of contacts to the browser via the HTTP link between the browser and the access server established using the XHR object.

In step S27, the browser determines whether the information of contacts received is complete, if yes, performs step S28; otherwise, performs step S25.

In step S28, the browser calls the callback function to display the complete information of contacts.

In the above steps, the HTTP link established between the XHR object and the access server is a short link. After receiving a message via the link, the access server checks whether there is a message to be sent in local storage, if there is, sends the message to the browser through the link and disconnects the link; otherwise, disconnects the link after a pre-defined time interval. After detecting that the link is disconnected, the browser re-establishes the link with the access server through the XHR object.

The detailed process of implementing instant messaging through the browser after the user logs in the access server is described hereinafter.

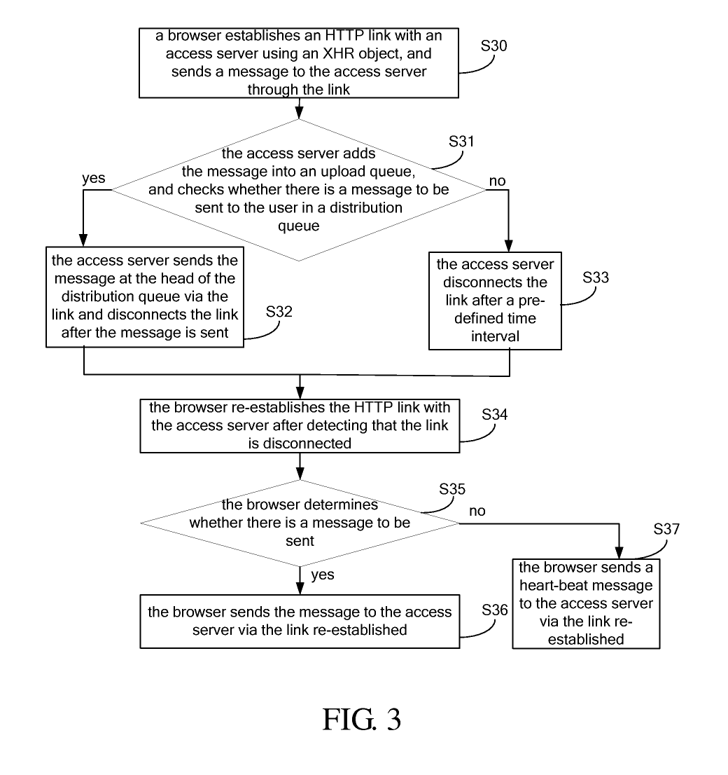

FIG. 3 is a flowchart illustrating a procedure of a user implementing instant messaging with a background server through a browser according to an embodiment of the present invention. As shown in FIG. 3, the method includes the following steps.

In step S30, when a user has a message to be sent, a browser determines whether there is an idle XHR object, if yes, establishes an HTTP link with an access server using the XHR object; otherwise, runs a JS script in a webpage to create an XHR object, establishes an HTTP link with the access server using the XHR object, and sends a message to the access server through the established HTTP link. Meanwhile, the browser designates a callback function for this type of message.

The message to be sent may be an instant message inputted by the user or a pre-defined system message, e.g. heart-beat message, which is sent automatically.

In step S31, the access server converts a message to be uploaded into the format of a protocol adopted by a background server before adding the message into an upload queue. At the same time, the access server checks whether there is a message to be sent to the user in a distribution queue, if there is, performs step S32; otherwise, performs step S33.

When receiving a message issued by the access server, the background server firstly converts the message into the HTTP protocol format and then adds the message into the distribution queue of the target user.

In step S32, the access server sends the message at the head of the distribution queue via the HTTP link and disconnects the HTTP link after the message is sent.

In step S33, the access server disconnects the link after a pre-defined time interval.

In step S34, the browser calls the callback function to process the message received and re-establishes the HTTP link with the access server after detecting that the link is disconnected.

In step S35, the browser determines whether there is a message to be sent in the local storage; if yes, performs step S36; otherwise, performs step S37.

In step S36, the browser sends the message to the access server via the link re-established.

In step S37, the browser sends a heart-beat message to the access server via the link re-established.

In the above procedure, the access server checks in real-time whether there is a message to be sent in the distribution queue; if yes, sends the message at the head of the distribution queue to the browser through the HTTP link established with the XHR object.

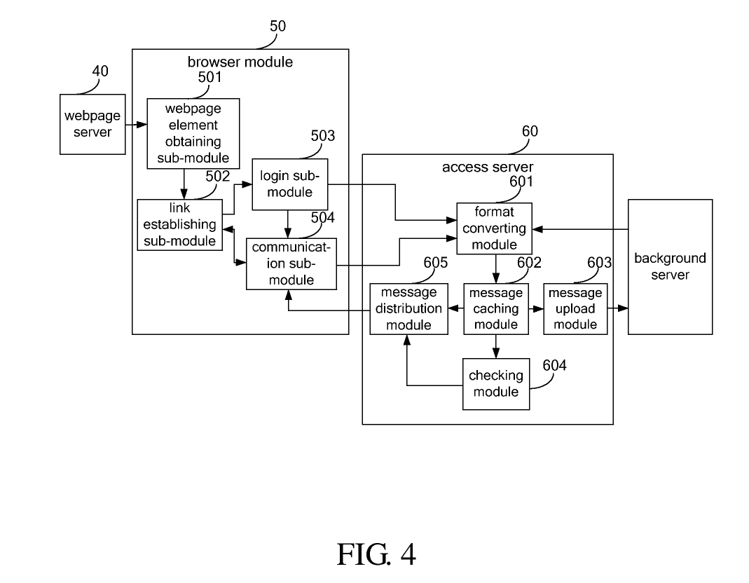

Corresponding to the above method for implementing instant messaging using a browser, embodiments of the present invention also provide a system for implementing instant messaging using a browser. FIG. 4 is a block diagram illustrating a system for implementing instant messaging using a browser in accordance with an embodiment of the present invention. As shown in FIG. 4, the system mainly includes webpage server 40, browser module 50 and access server 60.

The webpage server 40 is adapted to provide a webpage to browser module 50 for instant messaging.

The browser module 50 is configured on the client side, and is adapted to obtain the webpage providing instant messaging services from the webpage server 40, log in a background server and obtain information of contacts from the background server; send and receive instant messages to and from an access server through an HTTP link established with the access server using an XHR object, designate a callback function for this type of message, call the callback function to process a received message, and re-establish the HTTP link with the access server when detecting that the HTTP link is disconnected.

The access server 60 is adapted to add the message sent by the browser module 50 into an upload queue, check whether there is a message to be sent to the user in a distribution queue; send the message at the head of the distribution queue to the browser module 50 via the HTTP link and disconnect the HTTP link after the message is sent if there is a message to be sent to the user, or disconnect the HTTP link after a pre-defined time interval if there is no message to be sent to the user.

The browser module 50 includes:

webpage element obtaining sub-module 501, adapted to obtain webpage elements of the webpage providing instant messaging service from the webpage server;

link establishing sub-module 502, adapted to establish the HTTP link with access server using the XHR object;

login sub-module 503, adapted to log in the background server, obtain the information of contacts from the background server and display the information in the webpage, where the process of the login sub-module 503 logging in the background server and obtaining the information of contacts may accord with steps S20 to S29 and will not be described herein;

communication sub-module 504, adapted to send and receive messages to and from the access server 60 through the HTTP link established, designate a callback function for the type of message, call the callback function to process a received message, and trigger link establishing sub-module 502 to re-establish the HTTP link with the access server 60 when detecting that the link is disconnected, check whether there is a message to be sent in local storage after the HTTP link is re-established, send the message to the access server 60 if there is a message to be sent, or send a heart-beat message to the access server 60 if there is no message to be sent.

The access server 60 includes:

format converting module 601, adapted to convert a to-be-uploaded message into the format of a protocol adopted by the background server before adding the message to an upload queue of a message storage module 602, convert a to-be-issued message into the format of a protocol adopted by the browser 50 before adding the message to a distribution queue of the message storage module 602;

message caching module 602, adapted to cache the to-be-uploaded message and the to-be-issued message;

message upload module 603, adapted to send the messages in the upload queue in turn to a corresponding background server for processing;

checking module 604, adapted to check whether there is a message to be sent in the distribution queue;

message distribution module 605, adapted to send a message at the head of the distribution queue to the browser module 50 through the HTTP link established with access server 60 using the XHR object.

It can be seen from the above that, in embodiments of the present invention, a message is sent to the access server from the browser through an HTTP link established between an XHR object and the access server. The access server adds the message into an upload queue and checks whether there is a message to be sent to the user in a distribution queue; if yes, the access server sends the message at the head of the distribution queue through the current HTTP link and disconnects the HTTP link after the message is sent; otherwise, the access server disconnects the HTTP link after a pre-defined time interval. Thus, instant messaging is achieved through the short links established successively between the browser and the access server.

The foregoing descriptions are only preferred embodiments of this invention and are not for use in limiting the protection scope thereof. Any changes and modifications can be made by those skilled in the art without departing from the principle of this invention and therefore should be covered within the protection scope as set by the appended claims.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A method for implementing instant messaging, comprising:
logging in, by a browser, an instant messaging background server through a webpage, sending and receiving instant messages through an access server.

2. The method of claim 1, further comprising:
obtaining information of contacts after logging in the instant messaging background server through the webpage and before sending and receiving instant messages through the access server.

3. The method of claim 2, wherein the obtaining information of contacts comprises:
sending, by the browser, a contact information request message to the access server, and
receiving information of contacts sent by the access server.

4. The method of claim 3, further comprising:
determining whether the information of contacts is complete after receiving the contact profile information from the access server, if the information is incomplete, sending another contact information request message to the access server and receiving information of contacts from the access server.

5. The method of claim 1, wherein the logging on the instant messaging background server through the webpage comprises:
receiving, by the browser, a user identifier and a password inputted by a user through the webpage, sending the user identifier and the password to the access server through a login request message; if receiving a response message indicating authentication success from the access server, being informed that the browser has successfully logged in the background server.

6. The method of claim 1, wherein the sending and receiving instant messages through the access server comprises:
establishing an HTTP link with the access server, sending instant messages to the access server through the HTTP link, and receiving instant messages sent by the access server through the HTTP link.

7. The method of claim 6, further comprising:
determining whether there is an instant message to be sent after establishing the HTTP link with the access server and before sending instant messages to the access server through the HTTP link, if an instant message inputted by the user is received within a pre-defined time period, sending the instant message to the access server through the HTTP link; otherwise, sending a heart-beat message to the access server through the HTTP link.

8. The method of claim 6, wherein the establishing the HTTP link with the access server and receiving instant messages sent by the access server through the HTTP link comprise:
disconnecting, by the access server, the HTTP link established with the browser after the browser receives the instant message sent by the access server through the HTTP link; establishing the HTTP link with the access server, sending an instant message to the access server through the HTTP link and receiving an instant message sent by the access server through the HTTP link after detecting that the HTTP link established with the access server is disconnected.

9. A system for implementing instant messaging, comprising: a webpage server, a browser module and an access server, wherein
the webpage server is adapted to provide a webpage to the browser module for instant messaging;
the browser module is adapted to obtain the webpage for instant messaging from the webpage server, log in an instant messaging background server through the webpage, establish an HTTP link with the access server, send and receive instant messages to and from the access server through the HTTP link; and
the access server is adapted to receive an instant message sent by the browser module through the HTTP link established with the browser module, forward the instant message to the instant messaging background server, receive an instant message sent by the instant messaging background server and forward the instant message to the browser module.

10. The system of claim 9, wherein the browser module comprises: a webpage element obtaining sub-module, a link establishing sub-module, a login sub-module and a communication sub-module;
the webpage element obtaining sub-module is adapted to obtain a webpage element of the webpage providing instant messaging service from the webpage server and send the webpage element to the link establishing sub-module;
the link establishing sub-module is adapted to receive the webpage element sent by the webpage element obtaining sub-module and establish the HTTP link with the access server using the webpage element;
the login sub-module is adapted to log in the background server; and
the communication sub-module is adapted to send and receive instant messages to and from the access server through the HTTP link.

11. The system of claim 10, wherein the login sub-module is further adapted to receive a user identifier and a password inputted by a user, send the user identifier and the password to the access server through a login request, successfully log in the instant messaging background server if receiving a response message indicating authentication success from the access server; send a contact information request message to the access server and receive information of contacts from the access server.

12. The system of claim 10, wherein the communication sub-module is further adapted to disconnect the HTTP link with access server after receiving the instant message, disconnect the HTTP link with the access server if not receiving an instant message within a pre-defined time interval; trigger the link establishing sub-module to re-establish the HTTP link with the access server when detecting that the HTTP link is disconnected, check whether there is a local instant message to be sent after the HTTP link is re-established, send the instant message to the access server if there is a local instant message to be sent, or send a heart-beat message to the access server if there is no local instant message to be sent.

13. The system of claim 10, wherein the access server comprises: a format converting module, a message caching module, a message upload module, a checking module and a message distribution module;
the format converting module is adapted to receive the message from the browser, convert the message into a format of a protocol adopted by the background server and send the message to the message caching module, receive an instant message sent by the background server, convert the message into a format of a protocol adopted by the browser and send the message to the message caching module;
the message caching module is adapted to cache the message sent from the format converting module;
the message upload module is adapted to send the message cached in the message caching module to the background server;
the checking module is adapted to check whether there is a message in the message caching module to be sent to the browser module, and send a message distribution instruction to the message distribution module if there is a message in the message caching module to be sent to the browser module;
the message distribution module is adapted to receive the message distribution instruction from the checking module, send the message to be sent in the message caching module to the browser module through the HTTP link.

14. An access server, comprising: a format converting module, a message caching module, a message upload module, a checking module and a message distribution module;
the format converting module is adapted to receive a message sent from a browser, convert the message into a format of a protocol adopted by a background server, send the message to the message caching module, receive a message sent by the background server, and convert the message into a format of a protocol adopted by the browser and send the message to the message caching module;
the message caching module is adapted to cache the message sent from the format converting module;
the message upload module is adapted to send the message sent from the browser and cached in the message storage module to the background server;
the checking module is adapted to check whether there is a message in the message caching module to be sent to the browser, and send a message distribution instruction to the message distribution module if there is a message in the message caching module to be sent to the browser;
the message distribution module is adapted to receive the message distribution instruction from the checking module, send the message to be sent to the browser in the message caching module to the browser through an HTTP link.
